(19) United States
(12) Patent Application Publication
(10) Pub. No.: US 2004/0202900 A1
(43) Pub. Date: Oct. 14, 2004

(54) Dual power source switching control

(76) Inventors: Jeanne S. Pavio, Paradise Valley, AZ (US); Joseph W. Bostaph, Gilbert, AZ (US); Chenggang Xie, Phoenix, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/411,016

(22) Filed: Apr. 9, 2003

(51) Int. Cl. H01M 16/00; H01M 8/04

(52) U.S. Cl. 429/9; 429/22; 429/23; 320/101

(57) ABSTRACT

A system and method for controlling or otherwise effectively managing cell voltage degradation in the operation of a fuel cell device comprises inter alia a fuel cell (110) in parallel electrical connection with a secondary power source (145) and an automated controller (155) for switching between power supplied from the fuel cell (100) and the secondary power source (145). Disclosed features and specifications may be variously adapted or optionally modified to control or otherwise optimize the rate of cell voltage degradation in any fuel cell system. Exemplary embodiments of the present invention may be readily integrated with other existing fuel cell technologies for the improvement of device package form factors, weights and other manufacturing and/or device performance metrics.

### FIELD OF INVENTION

The present invention generally concerns fuel cell technology. More particularly, the present invention involves a system and method for controlling or otherwise managing cell voltage degradation in the operation of a fuel cell device and providing non-interrupt power to a device.

### BACKGROUND OF THE INVENTION

Fuel cells are electrochemical cells in which a free energy change resulting from a fuel oxidation is converted into electrical energy. The earliest fuel cells were first constructed by William Grove in 1829 with later development efforts resuming in the late 1930's with the work of F. T. Bacon. In early experiments, hydrogen and oxygen gas were bubbled into compartments containing water that were connected by a barrier through which an aqueous electrolyte was permitted to pass. When composite graphite/platinum electrodes were submerged into each compartment and the electrodes were conductively coupled, a complete circuit was formed and redox reactions took place in the cell: hydrogen gas was oxidized to form protons at the anode (e.g., “hydrogen electrode”) and electrons were liberated to flow to the cathode (e.g., “oxygen electrode”) where they subsequently combined with oxygen.

Since that time, interest in the development of viable commercial and consumer-level fuel cell technology has been renewed. In addition to various other benefits compared with existing conventional methods, fuel cells generally promise improved power production with higher energy densities. An additional advantage of fuel cells is that they are intrinsically more efficient than methods involving indirect energy conversion. In fact, fuel cell efficiencies have been typically measured at nearly twice those of thermo-electric conversion methods (i.e., fossil fuel combustion heat exchange).

With respect to portable power supply applications, fuel cells function under different principles as compared with standard batteries. As a standard battery operates, various chemical components of the electrodes are depleted over time. The battery is an energy storage device. In a fuel cell, however, as long as fuel and oxidant are continuously supplied, the cell's electrode material is generally not consumed and therefore will not run down or require recharging or replacement.

One class of fuel cells currently under development for general consumer use are hydrogen fuel cells, wherein hydrogen-rich compounds are used to fuel the redox reaction. As chemical fuel species are oxidized at the anode, electrons are liberated to flow through the external circuit. The remaining positively-charged ions (i.e., protons) then move through the electrolyte toward the cathode where they are subsequently reduced. The free electrons combine with, for example, protons and oxygen to produce water—an environmentally clean byproduct.

Direct Methanol Fuel Cell (DMFC) uses diluted methanol solution as fuel, which would greatly simplify the system; however, fuel cell performance typically degrades over time as cell voltage drops to the point where the fuel cell may no longer be capable of generating enough power to run the device. Broad application of fuel cell technology to inter alia portable consumer-level devices presents previously unresolved problems with respect to this issue of cell voltage degradation. Accordingly, a representative limitation of the prior art concerns the effective and efficient delivery of sustained voltage during the operation of a fuel cell device.

### SUMMARY OF THE INVENTION

In various representative aspects, the present invention provides inter alia a system and method for controlling, or otherwise effectively managing, cell voltage degradation in the operation of a fuel cell device. In one exemplary aspect, the present invention provides a hybrid power supply comprising a primary power source, a fuel cell, in parallel connection with a secondary power source, (a battery or other power source such as solar cell or another fuel cell) and a feedback control element for switching between power supplied from the primary power source and the secondary power source. Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being had to the accompanying drawings forming a part hereof, wherein like numerals refer to like parts throughout. Other elements, operational features, applications and/or advantages will become apparent to skilled artisans in light of certain exemplary embodiments recited in the detailed description, wherein:

FIG. 1 illustrates a block circuit diagram corresponding to representative components of a fuel cell power switching system in accordance with an exemplary embodiment of the present invention; and

FIG. 2 illustrates a representative voltage profile as a function of time corresponding to operation of the fuel cell system generally depicted, for example, in FIG. 1;

FIG. 3 illustrates a representative minimum voltage profile as a function of time corresponding to operation of the fuel cell system generally depicted, for example, in FIG. 1.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention.

Furthermore, the terms ‘first’, ‘second’, and the like herein, if any, are used inter alia for distinguishing between similar elements and not necessarily for describing a sequential or chronological order. Moreover, the terms front, back, top, bottom, over, under, along and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

The following descriptions are of exemplary embodiments of the invention and the inventor's conception of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system for controlling or otherwise managing cell voltage degradation in a fuel cell system. Certain representative implementations may include, for example: controlling the concentration of fuel in a fuel cell solution; controlling the concentration of gaseous phase chemical species in a fuel cell solution; or controlling the rate of elimination of exhaust gases from a fuel cell. As used herein, the terms “delivery” and “transport”, or any variation or combination thereof, are generally intended to include anything that may be regarded as at least being susceptible to characterization as or generally referring to the movement of at least one chemical compound from one area to another area so as to: (1) relatively decrease the concentration in or around one area, and/or (2) relatively increase the concentration in or around another area. The same shall properly be regarded as within the scope of the present invention. As used herein, the terms “fuel”, “fluid” and “solution”, or any variation or combination thereof, are generally intended to include any anode fuel solution and/or cathode oxidant solution whether or not the solution has been pre-conditioned or post-conditioned with respect to exposure to a fuel cell's electrode elements.

A detailed description of an exemplary application, namely the management and control of delivery of oxidant and fuel to the fuel cell and management of power distribution within power source, is provided as a specific enabling disclosure that may be generalized by skilled artisans to any application of the disclosed system and method for controlling cell voltage degradation and providing non-interrupted power for the user in any type of fuel cell in accordance with various embodiments of the present invention. Moreover, skilled artisans will appreciate that the principles of the present invention may be employed to ascertain and/or realize any number of other benefits associated with controlling the transport of fuel in a fuel cell and managing power distribution and power conditioning.

Fuel Cells

In the broadest sense, a fuel cell may be generally characterized as any device capable of converting the chemical energy of a supplied fuel directly into electrical energy by electrochemical reactions. This energy conversion corresponds to a free energy change resulting from an oxidation-reduction reaction, he oxidation of a supplied fuel coupled with ionic reduction of oxygen. A typical prior art fuel cell consists of an anode (e.g., ‘fuel electrode’) that provides a reaction site to generate electrons and protons and a cathode (e.g., ‘oxidant electrode’) to reduce spent fuel ions in order to produce a voltage drop across the external circuit. The electrodes are generally ionically porous electronic conductors that include catalytic properties to provide significant redox reaction rates. At the anode, incident hydrogen gas catalytically ionizes to produce protons (e.g., electron-deficient hydrogen nuclei) and electrons. At the cathode, incident oxygen gas catalytically reacts with protons migrating through the electrolyte and incoming electrons from the external circuit to produce water as a byproduct. Depending on various operational parameters of the fuel cell, byproduct water may remain in the electrolyte, thereby increasing the volume and diluting the electrolyte, may be discharged from the cathode as vapor, or stored in a reservoir for later use. The anode and cathode are generally separated by an ion-conducting electrolytic medium (i.e., PEM's or alkali metal hydroxides such as, for example: KOH, NaOH and the like). In early fuel cell experiments, hydrogen and oxygen were introduced into compartments and respectively while the electrodes, where conductively coupled by an external circuit to power a load where electrical work could be accomplished. In the external circuit, electric current is generally transported by the flow of electrons, whereas in the electrolyte, current is generally transported by the flow of ions. In theory, any chemical substance capable of oxidation (i.e., hydrogen, methanol, ammonia, hydrazine, simple hydrocarbons, and the like)which may be supplied substantially continuously may be used as galvanically oxidizable fuel at the anode. Similarly, the oxidant (i.e., oxygen, ambient air, etc.) may be selected to be any substance that can oxidize spent fuel ions at a sufficient rate to maintain a suitable voltage drop across the external circuit.

One process for fueling a hydrogen cell comprises that of ‘direct oxidation’ methods. Direct oxidation fuel cells generally include fuel cells in which an organic fuel is fed to the anode for oxidation without significant pre-conditioning or modification of the fuel. This is generally not the case with ‘indirect oxidation’ (e.g., “reformer”) fuel cells, wherein the organic fuel is generally catalytically reformed or processed into organic-free hydrogen for subsequent oxidation. Since direct oxidation fuel cells do not generally require fuel processing, direct oxidation provides substantial size and weight advantages over indirect oxidation methods. See, for example, in U.S. Pat. Nos. 3,013,908; 3,113,049; 4,262,063; 4,407,905; 4,390,603; 4,612,261; 4,478,917; 4,537,840; 4,562,123; 4,629,664 and 5,599,638.

Another well-known type of fuel cell component is known as a ‘membrane-electrode assembly’ (MEA), as generally described for example in U.S. Pat. No. 5,272,017 to Swathirajan. One exemplary embodiment of such an MEA component includes a Direct Methanol Fuel Cell which comprises a thin, proton-transmissive, solid polymer-membrane electrolyte having an anode on one of its faces and a cathode on an opposing face. The DMFC MEA anode, electrolyte and cathode may also be sandwiched between a pair of electrically conductive elements which serve as current collectors for the anode and cathode respectively and contain appropriate channels and/or openings for generally distributing the fuel (i.e., methanol and water, in the case of a DMFC device) and oxidant reactants (i.e., oxygen) over the surfaces of the corresponding electrode catalyst. In practice, a number of these unit fuel cells may be stacked or grouped together to form a ‘fuel cell stack’. The individual cells may be electrically connected in series by abutting the anode current collector of one cell with the cathode current collector of a neighboring unit cell in the stack.

As the DMFC anode is fueled with a mixture of methanol and water, the oxidation reaction generally proceeds in three steps: (1) methanol oxidizes to methanal (e.g., formaldehyde), releasing two electrons; (2) methanal oxidizes to methanoic acid (e.g., formic acid), releasing two electrons; and (3) methanoic acid oxidizes to carbon dioxide, releasing another two electrons. In various embodiments of exemplary DMFC's, the oxidation reaction may be started at any point in the multi-step series since the two intermediates (methanal and methanoic acid) are generally readily obtainable. It is generally believed, however, that the first oxidative step (methanol to methanal) is the rate-determining step of the overall reaction given spectroscopic studies indicating that methanal and methanoic acid appear in relatively low concentrations. This would generally suggest that the intermediates are rapidly oxidized and accordingly, the reaction steps corresponding to their oxidative consumption would be expected to have larger kinetic rate constants. The net anode reaction for a direct methanol-fueled device is therefore generally given as:

CH₃OH+H₂O→6H⁺+6e⁻+CO₂

Typically, the current produced by a DMFC is proportional to the net reaction rate, wherein one ampere corresponds approximately to 1.04E18 reactions per second. As aqueous methanol is oxidized at the anode, electrons are liberated to flow through an external circuit to power a load where electrical work may be accomplished. Protons migrate through the proton-transmissive electrolytic membrane where they subsequently are combined with oxygen that has been reduced with incoming electrons from the external circuit with water formed as a result.

Since in DMFC, the power generation process in the anode side uses one water molecule for every methanol molecule, without recycling water, the maximum energy density of the fuel cartridge is 4780 Wh/L*62%=3320 Wh/L (4780 Wh/L is the energy density of pure methanol). In order to achieve maximum energy density, we have to use pure methanol as basic fuel. To do that, we have to be able to recover the water produced as a by-product of the power generation process and dilute pure methanol into 3-6% fuel. Besides fuel cell and fuel tank, the system needs various auxiliaries including two liquid pumps, one air pump, a methanol sensor and a mixing chamber, which often called the balance of plant (BOP) to support the operation. In the system, pure methanol fuel is diluted inside a mixing chamber by mixing pure methanol with returned fuel from the anode and water collected at the cathode. The methanol concentration in the mixing chamber is monitored at all times by a methanol sensor and controlled by a fuel injection method. Diluted fuel is provided to the anode by a liquid pump. The air is supplied to the cathode by an air pump. The electronics includes the power management, power conditioning, pump drivers, startup circuit, and fuel cell protection. Because we use 100% methanol as refillable fuel, this system has the potential to achieve high energy density.

Portable Power Supplies

Standard batteries have generally dominated the available choices for portable power storage solutions for consumer-level electronic equipment in the past. Some of the disadvantages associated with standard batteries, however, is that they generally provide power for a relatively short duration of time and thereafter require recharging or replacement. Fuel cells, on the other hand, have many of the consumer-oriented features typically associated with standard batteries (i.e., providing quiet power in a convenient and portable package) in addition to other representative advantages including, for example, long usage lifetimes and the ability to be fueled with liquid or gaseous compounds rather than ‘solid fuels’ as used in conventional batteries.

Dual Power Source Switching Control System

In general, the performance of direct methanol fuel cells typically degrades (particularly under continuous load conditions) to the point where the fuel cell may no longer be capable of sustaining a voltage potential suitable for powering the load device. Although some component of this degradation is generally regarded as somewhat persistent, most of the degradation is believed to be temporary. The present invention, in several representative aspects, provides an exemplary system and method for recovering or otherwise managing voltage degradation in such a fuel cell device.

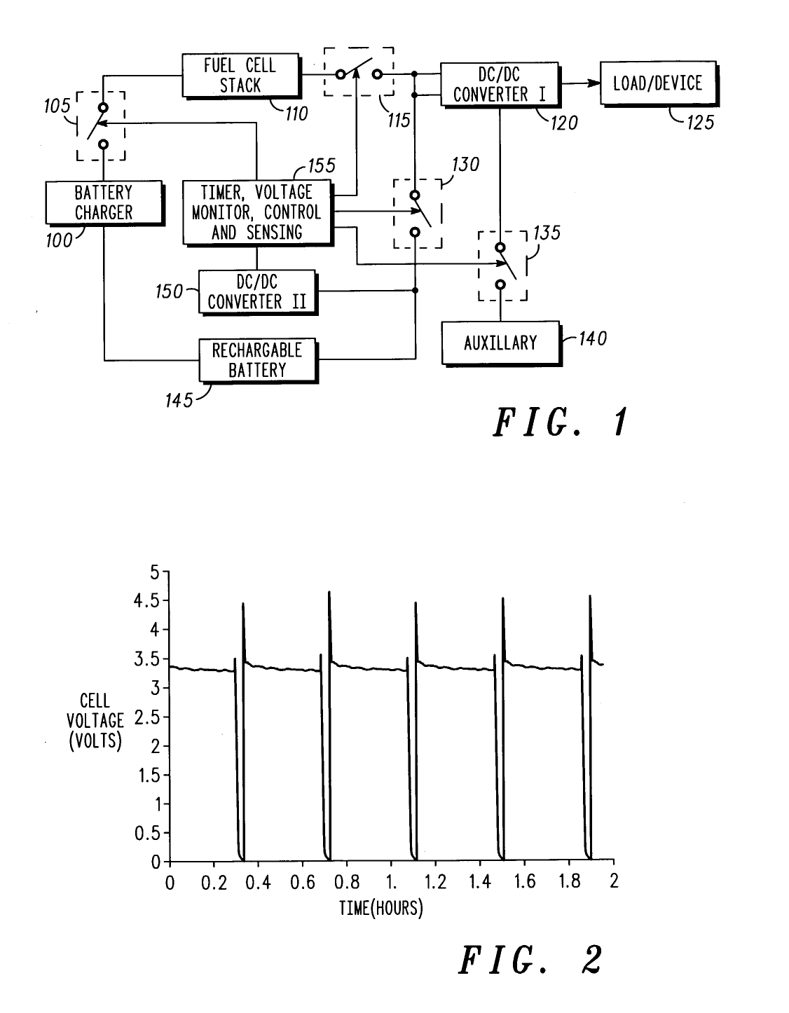

In accordance with one exemplary embodiment of the present invention, as representatively illustrated, for example, in FIG. 1, a system designed to periodically interrupt fuel and oxidant flow at both cathode and anode of a fuel cell 110 by, for example, shutting off the air supply to the fuel cell cathode for a period of time while switching to a secondary energy source (e.g., small rechargeable battery 145 or solar cell or super-capacitor or a second fuel cell) to provide backup power is disclosed. Such a system may comprise a battery 145 and a fuel cell 110 connected in parallel, which is controlled and switched via an automatic monitoring and feedback loop control element 155. Control element 155 allows for battery 145 operation of the system during high demands, during start-up and at periodic intervals defined by, for example, time or voltage values and allows for fuel cell control to manage average power requirements and charging demands of the battery 145.

As the exemplary device generally depicted in FIG. 1 is powered-up, switch 130 and switch 135 may be actuated by control component 155 in order to bring auxiliary components 140 (e.g., pump devices, sensors, etc.) online to begin the power-up of fuel cell 110. Until fuel cell 110 is operational, switch 130 may be actuated to provide power from battery 145 to load device 125. As fuel cell 110 becomes substantially operational, switch 130 may then be opened to disconnect power supplied from battery 145 while switch 115 may be closed in order to power load device 125 with current drawn from fuel cell 110. Where fuel cell 110 is designed to be capable of powering load device 125 with at least a partial excess of power, the device may further comprise a battery charger 100 actuated by switch 105 for at least partially recharging battery 145 during the operational duty cycle of fuel cell 110. Various exemplary embodiments of the present invention may also include DC/DC converters 120,150 configured, for example, to operate as charge pumps or otherwise adapted to condition power for subsequent use.

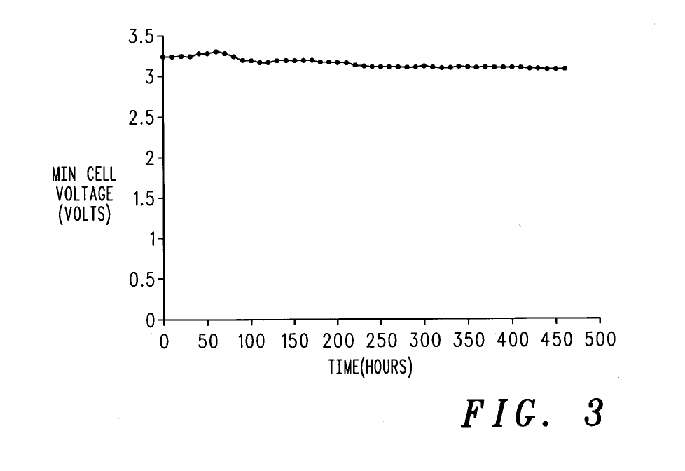

In one exemplary embodiment, as the fuel cell begins to experience cell voltage degradation, control element 155 may be configured to periodically provide a timed interrupt of air flow (i.e., oxygen) and fuel flow and/or air flow to fuel cell 110. For example, as generally illustrated in FIG. 2, as fuel cell 110 begins to experience a degradation in voltage potential, oxidant flow and/or fuel flow to fuel cell 110 may be switched off via switch 135 to temporarily shut-down fuel cell (see, for example, ˜0.3-0.33 hours in FIG. 2) such that fuel cell performance may be at least partially restored. As one of examples, the fuel cell system runs for 20 minutes and is stopped for 2 minutes. Without implementing the interrupt procedure, the degradation rate is 5 mV/hour/cell. After using 20 mins on/2 minutes off procedure, the degradation rate drops to 0.04 mV/hour/cell, at least 100 time improvement. The ratio of on-time and off-time may be determined based on the characteristics of the system as well as the power requirement of the targeted applications. Typically, the duty cycle (the ratio of on-time to sum of on-time and off-time) may be about 90% or higher to fully utilize the fuel cell. The on-time may be between about 1 minutes to a few days. In a preferred embodiment, the on-time may be less than about one hour. In the more preferred embodiment, the on-time may be less than about 30 minutes. The disclosed procedure generally does not stop cell voltage degradation of fuel cell during continuous operation. It recovers at least partial degradation by stopping fuel cell operation. For a typical fuel cell system, there is a cell voltage window within which the system may be operated stably. One examples is between 0.4 volts to 0.6 volts. If the cell voltage drops below 0.4 volts, the system generally becomes unstable. During the period of fuel cell operation, the cell voltage drop is generally equal to the time times the intrinsic degradation rate. For example, if the intrinsic degradation rate is 5 mV/hour/cell and the on-time is 20 hours, the voltage drop during 20 hour operation is 0.1V. This effectively reduces the operating window by 0.1 V. However, if the on-time is 20 minutes, the voltage drop during 20 minutes operation may be about 0.0017 V. The effective operating window is generally given as 0.1983 V. Another advantage of using short on time is to force the system to operate at higher cell voltage. Operating at higher cell voltages generally provides more efficient energy conversion. One of the parameters used to determine how long the system needs to rest in order to gain partial recovery is the discharging time for the fuel cell voltage to drop to near zero volts after the fuel and air flows are stopped to the fuel cell. Insufficient discharging time may reduce the degree of the recovery. This time-based procedure, as generally depicted for example in FIG. 2 may be repeated at regularly timed intervals and/or as needed. The resulting minimum cell voltage profile as a function of time, as generally illustrated for example in FIG. 3, results in relatively flat (i.e., stable) voltage performance of fuel cell 110 over time, despite the intermittent occurrence of cell voltage degradation.

In another exemplary embodiment, as the cell voltage degrades closer to the minimum cell voltage required for the system, control element 155 may be configured to provide an interrupt of air flow (i.e., oxygen) and fuel flow or just air flow to fuel cell 110 for a period of time. The off time can be between about 1 minutes to about 10 hours depending on the size and conditions of the system. After interrupt, the fuel cell may be at least partially recovered. This voltage-based procedure may be repeated regularly.

In another exemplary embodiment, as the cell voltage degrades, control element 155 may be configured to provide an interrupt of air flow (i.e., oxygen) and fuel flow or just air flow to fuel cell 110 either using the time-based procedure or voltage-based procedure depending on the status of cell voltage and loading condition. After interrupt, the fuel cell may be at least partially recovered. This procedure may also be repeated regularly.

An exemplary switching control system, in accordance with various representative embodiments of the present invention, may be achieved using switching IC or mechanical switches or valves or combination of both. For electric switching, the control system may be integrated in one or two IC chips to further reduce the cost of the system.

Accordingly, at least one representative benefit provided by dual power source switching control systems in accordance with various exemplary embodiments of the present invention, is that such systems may deliver optimum hybrid fuel cell power performance in an automated mode in addition to allowing the fuel cell 110 to be designed much smaller, to handle average rather than peak power loads as well as permitting cold start-up operation. Where control element 155 has been described as using a timed interrupt sequence vide supra, skilled artisans will appreciate that a variety of other metrics may be alternatively, conjunctively and/or sequentially employed to produce a substantially similar article of manufacture and/or a substantially similar functional result. For example, control element 155 may be adapted to monitor at least one of voltage trends and/or fluctuations, pH, fuel component concentrations, temperature, load current and/or any other performance metric whether now known or hereafter otherwise described in the art. Additionally, various embodiments for controlling or otherwise managing cell voltage degradation of the present invention may be applied to any fluid fuel cell system (direct and/or reformed).

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A hybrid power supply device, comprising a first fuel cell in parallel electrical connection with a second power source and an automated control element configured to switch between power supplied from said fuel cell and power supplied from said second power source.

2. The device of claim 1, wherein said fuel cell comprises at least one of a methanol fuel cell, a direct methanol fuel cell, a direct liquid fuel feed fuel cell and a reformer fuel cell.

3. The device of 2, wherein said automated control element is further configured to shut down operation of said fuel cell when power is supplied from said second power source.

4. The device of 1, wherein said second power source comprises at least one of a solar cell, a rechargeable battery, and a second fuel cell and a disposable battery.

5. The device of claim 1, wherein said automated control element is configured to actuate deprivation of at least one of oxygen at the cathode and fuel at the anode of said fuel cell for a predetermined length of time.

6. The device of claim 1, further comprising a battery charging component and wherein said automated control element is configured to actuate said battery charging element in order to at least partially charge a battery with power effectively drawn from said fuel cell.

7. The device of claim 1, wherein said automated control element is configured to actuate a plurality of solid-state switches.

8. The device of claim 1, further comprising at least one DC/DC converter.

9. The device of claim 1, wherein said automated control element comprises a feedback loop responsive to at least one of elapsed time, voltage, pH, fuel concentration, temperature and load current.

10. The device of claim 9, further comprising means for monitoring said feedback during at least one of fuel cell startup and high load demand.

11. A method for supplying power with the hybrid device of claim 1, said method comprising the steps of:
providing a first fuel cell;
providing a second power source;
said fuel cell and said second power source in parallel electrical connection with each other; and
providing an automated control element for switching between power supplied from said fuel cell and power supplied from said second power source.

12. The method of claim 11, further comprising the step of switching between power supplied from said first fuel cell and power supplied from said second power source.

13. The method of 12, further comprising the step of said control element shutting down operation of said fuel cell and supplying power from said second power source.

14. The method of claim 13, wherein said control element actuates a deprivation of at least one of oxygen at the cathode and fuel at the anode of said fuel cell.

15. The method of claim 11, further comprising the steps of providing a battery charging element and said control element actuating said battery charging element in order to at least partially charge a battery.

16. The method of claim 11, further comprising the step of said automated control element actuating a plurality of solid-state switches.

17. The method of claim 11, further comprising the step of providing at least one DC/DC converter.

18. The method of claim 11, further comprising the step of providing a feedback loop and wherein said automated control element switches between power supplied from said first fuel cell and power supplied from said second power source in response to monitoring said feedback loop.

19. The method of claim 18, wherein said monitoring of said feedback loop is responsive to at least one of elapsed time, voltage, pH, fuel concentration, temperature and load current.

20. The method of claim 19, further comprising the step of monitoring said feedback during at least one of fuel cell startup and high load demand.

21. The method of claim 12, further comprising the steps of:
restarting said first fuel cell after a short rest; and
repeating the step of switching between power supplied from said first fuel cell and power supplied from said second power source as needed.

22. The method of claim 21, wherein said first fuel cell has a duty cycle of up to about 90% and a rest cycle comprising short intervals to keep the cell voltage high.

23. A method for supplying power with the hybrid device of claim 1, said method comprising the steps of:
providing a direct methanol fuel cell;
providing a rechargeable battery;
said fuel cell and said battery in parallel electrical connection with each other; and
providing an automated control element for supplying power from said battery and depriving said fuel cell cathode of air supply as a function elapsed time of fuel cell operation.
